(19) United States
(12) Patent Application Publication
(10) Pub. No.: US 2011/0168846 A1
(43) Pub. Date: Jul. 14, 2011

(54) STATIC LINE PIGGYBACK PARACHUTE SYSTEM

(76) Inventor: Edward Strong, Orlando, FL (US)

(21) Appl. No.: 12/684,179

(22) Filed: Jan. 8, 2010

(51) Int. Cl. B64D 17/62; B64D 17/50; B64D 17/30; B64D 17/64; B64D 17/40

(52) U.S. Cl. 244/148; 244/147; 244/149

(57) ABSTRACT

A parachute container system including: a reserve compartment; a main compartment; a reserve parachute pathway configured to enable a mechanical connection between a reserve parachute canopy and a reserve parachute connection point external to the parachute container system when a reserve parachute canopy is positioned in the reserve compartment; and a main parachute pathway configured to enable a mechanical connection between a main parachute canopy and a main parachute connection point external to the parachute container system when a main parachute canopy is positioned in the main compartment. When the parachute container system is positioned on a parachutist at least a portion of the reserve compartment is disposed between the main compartment and the parachutist.

### FIELD OF THE INVENTION

This invention relates to parachute systems. Particularly, this invention relates to an improved parachute system for parachute jumping when the parachutist may be oriented parallel to a line of deployment of the main parachute, such as static-line jumping.

### BACKGROUND OF THE INVENTION

Static-line parachute jumping is one form of parachute jumping where the parachutist may be oriented parallel to a line of a deploying main parachute. In conventional static-line parachute jump operations a parachutist wears a harness that holds a main parachute container on the parachutists back. The main parachute container houses a main parachute retained inside a main parachute deployment-bag. A separate reserve container is attached to the harness on the front side of the parachutist. A tether known as a static-line is attached to the aircraft at a first end. Near the second end the static-line is attached to a mechanism that will open the main parachute container. At the extreme second end the static-line is attached to the main parachute deployment-bag. Upon exiting the aircraft and during descent the parachutist remains in an essentially feet down, head-up, (albeit tucked), vertical orientation. Once the parachutist descends a sufficient distance the static-line becomes taut and releases the mechanism holding the main parachute container closed, thereby freeing the main parachute deployment-bag to extract. At this point the parachutist and the static-line are nearly parallel. The parachutist continues to descend, but the main parachute deployment-bag, which is still connected to the aircraft via the static-line, does not. Main parachute suspension lines that connect the main parachute (still in the main parachute deployment-bag) to the descending parachutist begin to pull free of line stows on the main parachute deployment-bag. The main parachute suspension lines continue to unstow from the line stows, and just prior to when the main parachute suspension lines are stretched nearly taut the main parachute suspension lines pull from the last-to-release line stows. This simultaneously unlocks the main parachute deployment-bag, which frees the main parachute to leave the main parachute deployment-bag, catch air, and inflate. The parachutist and main parachute continue to descend as the main parachute inflates, while the static-line and main parachute deployment-bag remain connected to the aircraft.

In the event of a malfunction in which the parachutist decides to discard the main parachute and deploy the reserve, the parachutist can cut-away the main parachute and deploy a reserve parachute. In a conventional static-line deployed main parachute system, the reserve container is attached to the harness on the front side of the jumper. This helps separate the main canopy and reserve canopy in the event of a malfunction. However, this configuration has several drawbacks. For instance, a bulky reserve parachute container so located is in front of and below a parachutist's eyes and therefore limits the parachutist's vision in that area. Vision in that area is particularly important because it is this area the parachutist must look to in order to properly prepare for impact upon landing. Additionally, front mounted reserve parachutes are difficult to deploy, and often static-line jumps of this nature are conducted under particularly unforgiving low-altitudes. Further, those conducting these types of parachute jumps often have the need to carry additional equipment, and could utilize the front of the harness were the reserve parachute and its container not already there. Even further, a reserve parachute so attached suspends a parachutist from a connection point on the chest. This awkwardly leans the parachutist back once under an inflated reserve canopy, which makes it more difficult to see forward and below, and presents further opportunity for back and/or neck injury during deployment and landing.

Other parachute operations employ parachute systems that are configured differently. For example, in sport and tandem parachuting operations, both the main parachute container and the reserve parachute container are typically located on the parachutist's back, with the reserve parachute container located above the main parachute container.

In static line parachuting the static line deploys the main parachute as the parachutist recedes from the aircraft as he descends. The results in a line between the parachutist, along the static line, to the aircraft, which becomes the line of deployment (since the static line deploys the main parachute). This line has a positive slope with respect to the surface of the earth. The body of the parachutist remains parallel to this line through deployment. The parachutist's path of descent, however, is simultaneously forward and down with respect to the surface of the earth, which forms a negative slope. Thus, in static line operations from forward moving aircraft, the path of descent and line of deployment may cross each other at angles approaching 90 degrees when both are viewed with respect to the surface of the earth. It is imperative that nothing interfere with the deployment of a parachute. Thus, in parachute operations such as static line jumps where the line of deployment is essentially parallel to the back/body of the parachutist, the parachute containers used must be designed to permit unobstructed deployment of the main parachute in a line parallel to the back of the parachutist.

Unlike static-line parachuting, in sport and tandem parachuting, where there is no connection to an aircraft or other object, the parachutist is typically oriented belly-down, i.e., facing the earth, at ninety degrees to the path of descent, when the parachute is deployed by the force of the wind on a pilot chute. The parachute deploys along the line of deployment, the line of deployment is parallel to the path of descent, and the line of deployment is at ninety degrees to the parachutist's back. (As a result, in sport and tandem parachuting, because the parachute is attached to the parachutist's shoulders, the parachutist's body will swing from the horizontal orientation to a vertical orientation as the parachute inflates.) Thus, parachute containers used in parachute operations where the line of deployment is essentially at 90 degrees to the back of the parachutist must be designed to permit unobstructed deployment of the main parachute in a line perpendicular to the back of the parachutist. Consequently, parachute containers used in parachute jumps where the line of deployment is parallel to the parachutist's body (i.e., static line) must be different than those used in parachute jumps where the line of deployment is perpendicular to the parachutist's body (i.e., sport and tandem).

The reserve parachute has been located on the front of the parachutist whose body is parallel to the line of deployment because the reserve container is entirely out of the path of a deploying main parachute. For sport and tandem parachuting, the parachute deploys at ninety degrees to the parachutist's back, so a reserve located on the parachutist's back adjacent to the main parachute does not interfere with the deployment of the main parachute. However, a parachuting system configured for sport or tandem parachuting is not suitable for use during parachuting operations when the parachutist's body is parallel to the line of deployment during deployment. This is because when the parachutist is so oriented, the main parachute container is located below the reserve parachute container. As a result, the deployment path of the main parachute would be blocked by the reserve container. In order to deploy, the main parachute would slam into the bottom of the reserve container, and would then have to work itself around the reserve container before deploying. At the very least this would cost valuable time. It could also push the reserve container forward and out of the way and into the parachutist's head, which may injure the parachutist and/or cause the parachutist to begin a forward roll during the deployment of the main parachute, which is an unwanted condition. At worst the main parachute may not deploy.

A sport or tandem container configuration is further unsuitable for deployment when parallel to the line of deployment because once the main parachute has deployed, the reserve parachute would remain on the parachutist's back slightly below the parachutist's neck. Often round parachutes are utilized during this type of parachuting, and these parachutes have low forward speeds of approximately 6-8 mph. Ground winds often exceed these conditions during parachuting operations, and in those cases the parachutist will be traveling backwards with respect to the ground when landing. As a result the parachutist may land rolling backwards, and the hard reserve container on the back of a parachutist that is landing backwards may hit the parachutist in the head causing injury, or may cause neck strain as the parachutist's roll is suddenly interrupted by the reserve container.

In addition, many sport and tandem reserve parachute activation systems require a greater amount of time and altitude to develop a fully inflated reserve parachute than may be available in parachuting operations when the parachutist is parallel to the line of deployment. Consequently, there exists a need for an improved parachute system for use in parachute operations when the parachutist's body is parallel to the line of deployment, such as static-line operations.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a side view of a conventional parachute system used when the body of the parachutist is parallel to the line of deployment of the main parachute.

FIG. 2 is a side view of the parachute system of the present invention.

FIG. 3 is a perspective view of the reserve free-bag of the parachute system.

FIG. 4 is a partial perspective view of the divider attached to the inside of the back wall of the reserve free-bag of FIG. 3.

FIG. 5 is a perspective view of the reserve free-bag of FIG. 3 with the reserve closing flap, the divider, and the sequencing line stows in the locked position.

FIG. 6 is a perspective view of the reserve free-bag of FIG. 5 holding a packed reserve parachute and partially stowed reserve parachute suspension lines.

FIG. 7 is a perspective view of the reserve free-bag of FIG. 6 with fully stowed reserve parachute suspension lines.

FIG. 8 is a cross sectional view of the parachute container holding packed main and reserve parachutes.

FIG. 9 is a side view of the parachute system showing the main parachute deployment-bag leaving the main parachute container unhindered by the reserve parachute container.

FIG. 10 is a side view of the parachute system showing the reserve parachute free-bag leaving the reserve parachute container unhindered by the main parachute container.

FIG. 11 shows the reserve free-bag at a distance from the parachutist that the stowed lines are about to begin unstowing.

FIG. 12 shows a side view of a container system with zippers.

FIG. 13 shows a back view of a harness system with zippers.

FIG. 14 shows a side view of a harness zippered to a container system.

### DETAILED DESCRIPTION OF THE INVENTION

The inventor of this innovative parachute system has created a parachute system for use in parachute operations where the parachutist is parallel to the line of deployment when the main parachute is deployed (i.e., “static-line” jumping), that positions both the main parachute and the reserve parachute on the back of the parachutist. By moving the reserve parachute from in front of the parachutist to behind the parachutist, between the main parachute and the parachutist, the inventor has created a system that overcomes many of the disadvantages of the prior art. While doing this the inventor has further created some advantages never before available in a parachute system.

Positioning the reserve container between the main container and the parachutist, such that it does not over-hang the main parachute container when the parachutist is vertically oriented, (i.e., during deployment of the main parachute), permits the innovative parachute system to utilize the basic principle of operation of the main parachute deployment system of the prior art. Thus, the main parachute deployment system of the present invention uses the time tested techniques of the prior art to effect the deployment of the main parachute. In particular, reserve container of the present invention remains free of the static-line during deployment when the parachutist is vertically oriented.

This positioning of the reserve container yields advantages not yet seen in the art, as discussed in further detail below. In the parachute system of the present invention, the reserve parachute deploys at least as fast, if not faster than in the prior art systems, without sacrificing reliability. The deployment of the reserve parachute may now also be achieved using automatic deployment systems available for sport and tandem parachute operation, but not available for parachute operations when the parachutist's body is parallel to the line of deployment, (i.e., static line jumping), until the creation of the parachute system of the present invention.

Further, there are at least two primary advantages that result solely from moving the reserve parachute from the front of the parachutist. First, the parachutist will now have unobstructed vision in front and below. This area of vision is critically important because this is where a parachutist must look in order to properly gauge and prepare for impact upon landing. Landings in parachute jumps using round parachutes are often hard, and if the parachutist is not able to adequately gauge the landing, injuries can and do occur. As a result of this advantage alone, injuries may be reduced. Second, the front of the parachute system has been freed such that other equipment may be attached. Other cargo has been attached to the front of the parachutist in the prior art, but there was always the risk that this other cargo might interfere with the operation of the reserve parachute. This risk is eliminated when there is no reserve in the front to interfere with. Additionally, attaching more cargo may or may not again block the view of the parachutist, but this system offers the parachutist the option to choose the configuration depending on the weather conditions, and the needs of the jump, which was not possible before.

The reserve parachute of the present invention has also been configured, when packed, to essentially be a relatively thin, flat “pad” along the parachutist's back. As a result, should the parachutist be in a situation such as rolling backwards upon landing, the reserve of the present invention acts as a smooth cushion, reducing the chances of injury.

As used herein, a parachute system includes at least main and reserve containers and parachutes, a main bag and a reserve bag into which the main and reserve parachutes a packed respectively, a harness, and a main and reserve extraction system. A parachute includes a canopy, suspension lines, and risers, where the suspension lines connect the canopy to the risers, and the risers attach to the parachutist at a parachute connection point. In an exemplary embodiment the suspension lines that connect the canopy to the risers can be, but are not limited to, flexible rope, such as Spectra™/microline, Vectran™, Dacron™, or Nylon. There is generally one parachute connection point at each of the parachutist's shoulders for a total of two parachute connection points per parachute, and typically the parachute connection points connect the risers to a harness. A deployment bag is a bag into which a parachute is packed that remains connected to the parachute or the static line after the parachute emerges from the deployment bag. A free-bag is a bag into which a parachute is packed, that does not remain connected to the parachute or the static line after the parachute emerges from the free-bag. An extraction system is a system designed to remove a bag containing a parachute from a parachute container. A conventional extraction system includes a pilot chute connected to a bag holding the reserve parachute via a reserve pilot chute tether. The reserve pilot chute enters the airstream, begins to forcefully separate from the descending parachutist, and delivers that extraction force via the reserve pilot chute bridle to the bag containing the reserve parachute. This force extracts the reserve parachute from the reserve parachute container. A path of descent is the path a parachutist travels during descent. A line of deployment is generally a line defined by the line formed by the components of a deploying parachute. The parachute container of the present invention is said to be vertically oriented when positioned as shown in FIG. 2. This is the same orientation it would be in if worn by a person standing on the ground. Deployment is the process that takes a parachute from being secured inside a container to the point where it is free to catch air and begin to inflate. Once fully and properly inflated the parachute can safely lower a parachutist to the ground. Deployment may include the steps of activating an extraction system, extracting the bag containing a parachute and stowed suspension lines, unstowing the suspension lines, unlocking the bag, and extracting the parachute from the bag.

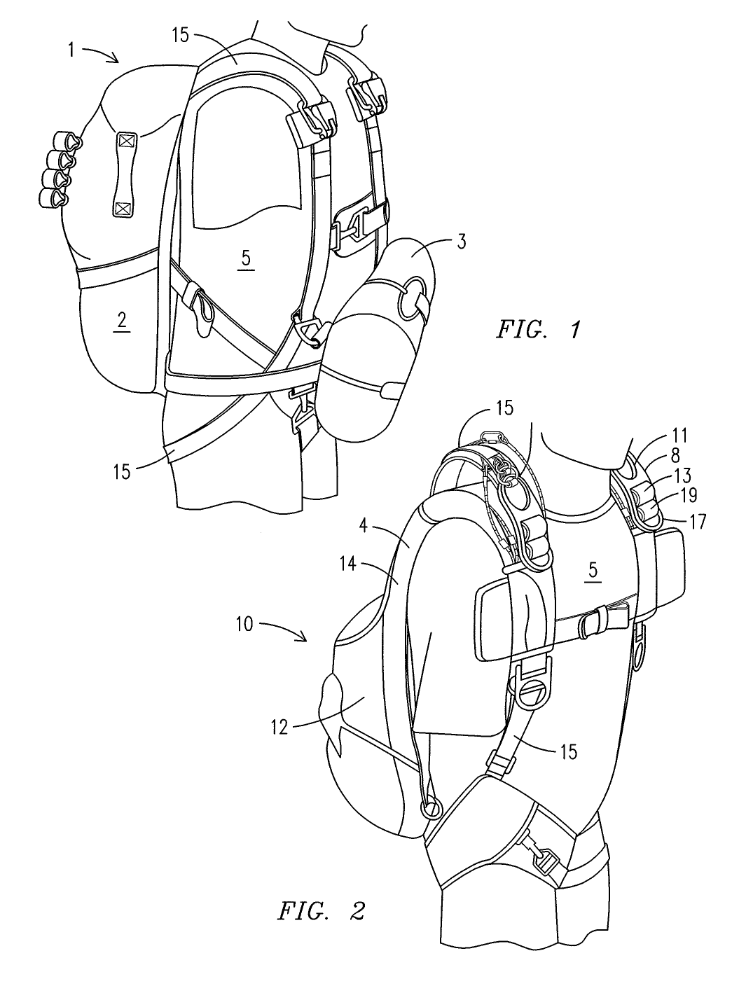

Turning to the drawings, FIG. 1 shows a parachute system 1 of the prior art, as worn by a parachutist 5. The prior art parachute system 1 includes a main parachute container 2 on the parachutist's back, a reserve parachute container 3 on the parachutist's chest, and a harness 15 with which the main parachute container 2 is integrated, and to which reserve parachute container 3 is attached.

FIG. 2 shows the parachute system 10 of the present invention, including a main container 12 in which a main parachute is stored, a reserve container 14 in which a reserve parachute is stored, and a harness 15. The reserve container 14 extends from the top of the parachute system 10 to the bottom of the parachute system 10, between the main container 12 and the parachutist 5. A 3-D Ring 8 is connected to the harness near the parachutist's shoulders. The 3-D Ring 8 has four separate connection points: a main parachute connection point 11; a reserve parachute connection point 13, a passenger or payload connection point 17, and a jumper harness connection point 19. The 3-D Ring and its operation are fully disclosed in U.S. Pat. No. 4,746,084 to Edward T. Strong of Orlando, Fla., which is incorporated herein by reference. As is known in the art, when a reserve parachute is packed and stored in the reserve container 14, the connection (i.e., the reserve parachute suspension lines and reserve risers) between the reserve canopy (not shown) and the reserve parachute connection point 13 is enabled via a reserve pathway 4. Typically there is a pathway along the interior of each side of the container system beginning near the bag in which the parachute is placed and opening near the parachute connection points 11, 13. When a parachute deploys, the suspension lines and riser are extracted from the pathway, thereby enabling a straight connection of the suspension lines and risers between the canopy and connection points. There are many such components that separate a parachute container for use in parachute jumps from common containers capable of simply storing a parachute therein. These are known to those of skill in the art and thus will not be discussed in depth herein.

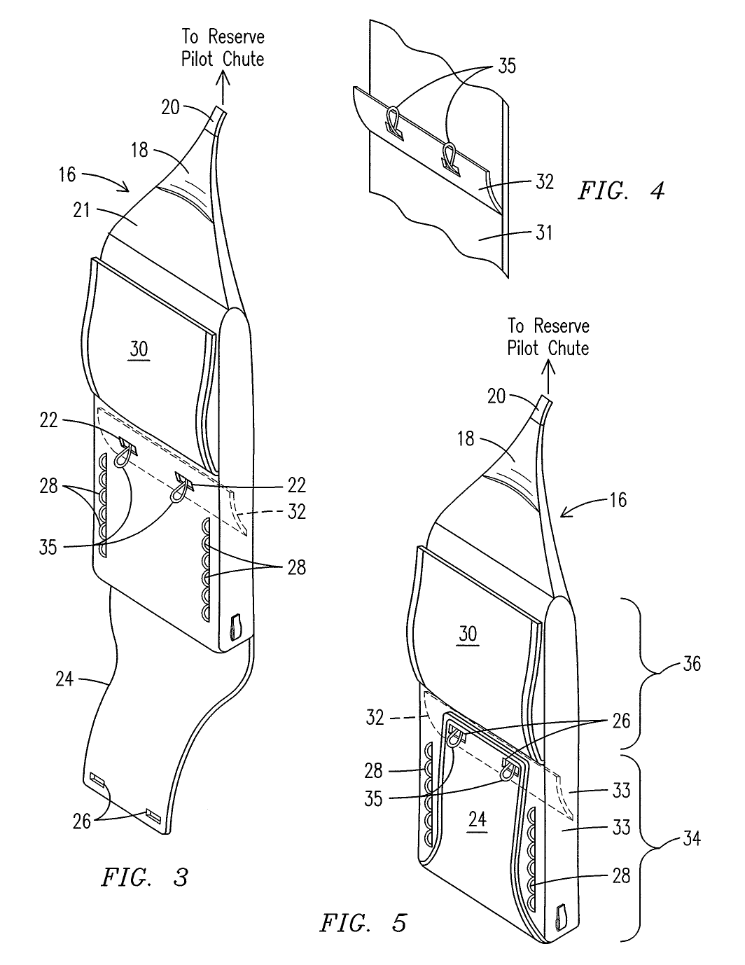

FIG. 3 shows a reserve free-bag 16 by itself and in an open configuration. The reserve free-bag 16 may be made from a flexible material, preferable one that does not bind, grab, or otherwise interfere with deployment from the reserve container 14. In an embodiment, cotton has been shown to be suitable. A reserve parachute (not shown) is packed into the reserve free-bag 16, and the reserve free-bag 16 in turn fits into the reserve container 14. Reserve free-bag 16 includes at least one extraction assist pocket 18 on vane 21. This pocket is designed to catch air as the reserve free-bag 16 is being extracted from the reserve container 14, thereby assisting the reserve free-bag 16 out of the reserve container 14. It further helps keep the reserve free-bag 16 stable (i.e., helps prevent spinning) during deployment. A single extraction assist pocket 18 is shown positioned at the top of the reserve free-bag 16, but more than one packet could be employed, such as a pocket on both sides of the reserve free-bag 16, and the pocket can be disposed anywhere on the vane 21 that would permit it to assist in the proper extraction of the reserve free-bag 16 from the reserve container 14. An extraction systems connection point 20 is the point at which reserve free-bag 16 extraction systems (not shown) connect to the reserve free-bag 16. Reserve free-bag 16 extraction systems are systems that extract the reserve free-bag 16 from the reserve container 14, and include reserve pilot chutes (not shown), and systems that releasably tether a main parachute to the reserve free-bag 16. These systems are known in the art so they will not be discussed in depth here.

Reserve free-bag 16 further contains free-bag sequencing line-stow openings 22, a closing flap 24, and closing flap sequencing line-stow openings 26. When the closing flap 24 is closed, the closing flap sequencing line-stow openings 26 line up with the free-bag sequencing line-stow openings 22, as will be discussed in more detail below. When the closing flap 24 is closed it fits between line stows 28. Also included is cover 30, which covers closing flap 24 and line stows 28. Divider 32 is also visible inside the reserve free-bag 16. Divider 32 is preferably a flexible material, and may be the same as the material that the reserve free-bag 16 is made of, such as cotton.

FIG. 4 shows the reserve free-bag 16 of FIG. 3, with the front and side panels removed. Divider 32 is attached to the back panel 31 only. Attached to divider 32 are sequencing line stows 35. Sequencing line stows 35 are known to those in the art and come in a variety of materials, from simple rubber-bands, to dedicated line stows, to fabric. The type of material determines how tight the line stows retain lines. Sequencing line stows 35 simply “stow” (i.e., retain) bundles of lines, such as parachute suspension lines, (not shown). This maintains the lines in an orderly fashion. Multiple line stows enable the lines to be stowed in sequence, so that during deployment the lines unstow in a predictable and controlled manner. It is important to stow the lines so they don't all deploy at once, because this could result in a malfunction where the lines knot up together.

FIG. 5 shows the reserve free-bag 16 of FIG. 3 in a closed configuration. In the closed configuration, closing flap 24 is closed and closing flap sequencing line-stow openings 26 line up with the free-bag sequencing line-stow openings 22. Sequencing line stows 35, which are attached to divider 32, are routed through closing flap sequencing line-stow openings 26 and free-bag sequencing line-stow openings 22. Once the sequencing line stows 35 are secured in this position, as will be discussed below, divider 32 divides the interior 33 of the reserve free-bag 16 into a lower compartment 34 and an upper compartment 36. When secured, divider 32 also aids the reserve free-bag 16 in a substantially rectangular shape, by acting as a structural member that keeps the opposing larger sides of the reserve free-bag 16 from bowing outward when the reserve parachute is tightly packed inside.

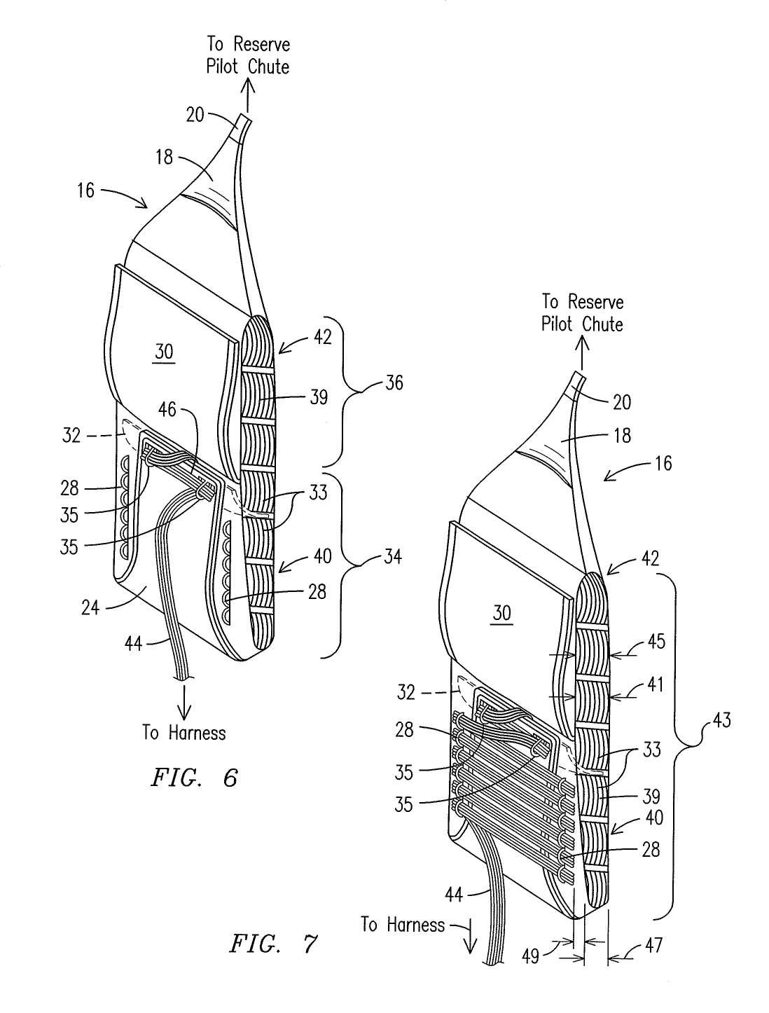

FIG. 6 shows the closed reserve free-bag 16 of FIG. 5, into which a reserve parachute 39 has been packed. Divider 32 has divided the reserve parachute 39 into a lower reserve parachute portion 40 and an upper reserve parachute portion 42. In an embodiment, the lower reserve parachute portion 40 is the portion of a round parachute 39 that the parachute suspension lines connect to, and the portion of the parachute canopy that emerges from the reserve free-bag first. In an embodiment, this may be a minority of the total canopy material, for example, approximately ten percent. Upper reserve parachute portion 42 may be at the center of the round reserve parachute 39, and may be the portion of a parachute canopy that emerges from the reserve free-bag last. In an embodiment, this may be a majority of the total canopy material, for example, approximately ninety percent. Suspension lines 44 are routed from lower reserve parachute portion 40 of the canopy to the sequencing line stows 35, where an upper section 46 of the suspension lines 44 are stowed. The reserve free bag 16 maintains a more or less constant depth from top to bottom.

The upper section 46 of the suspension lines 44 stowed in the sequencing line stows 35 are close to the canopy portion of the round reserve parachute 39, and are the last to unstow during a deployment. Stowing the upper section 46 in the sequencing line stows 35 locks the sequencing line stows 35 into position, (i.e., prevents the sequencing line stows 35 from retracting through the openings). This, in turn, locks closing flap 24 in place, as well as locks divider 32 in place. Locking closing flap 24 in place locks the reserve parachute 39 inside the reserve free-bag 16. Locking divider 32 in place locks the upper reserve parachute portion 42 in the upper compartment 36, and the lower reserve parachute portion 40 in the lower compartment 34. Line stows 28 are also visible.

FIG. 7 shows the closed reserve free-bag 16 of FIG. 6, where the suspension lines 44 have been stowed in line stows 28. It can be seen that the suspension lines 44 are naturally stowed in order, from that portion which connect to the canopy portion of the reserve parachute 39 at the top, toward the end of the line stows that is attached to the harness (not shown in FIG. 7) at the bottom. Conversely, it can be understood that once the reserve free-bag 16 is extracted from the reserve container 14 (this process will be described in more detail below) and moves away from the parachutist, suspension lines 44 will unstow from the bottom of the line stows to the top, and the last to unstow will be the sequencing line stows 35. The sequencing system of the present invention, which includes divider 32, sequencing line stows 35, and closing flap 24, relies on this order.

Many factors combine to determine the rate of speed at which a parachutist is traveling when an extraction system begins to extract a reserve parachute. At one end of the range, a parachutist may be under a fully inflated canopy with a relatively slow rate of descent when the decision to employ the reserve parachute 39 is made. A reserve extraction under these circumstances may be relatively benign on the jumper and equipment. At the other end of the range a parachutist may be at terminal velocity, easily exceeding 120 mph. Reserve parachutes are designed for emergency situations, where altitude is at a premium, and thus they are designed to and may open faster than a main parachute. A terminal velocity deployment of a reserve parachute can therefore be relatively sudden, with great stresses on the parachutist and parachute equipment.

Extracting a reserve free-bag 16 at terminal velocity imparts sudden and drastic acceleration on the reserve free bag 16, the reserve parachute 39 inside it, and the suspension lines 44 stowed in the line stows 35, 28. Specifically, the reserve free bag 16 and its contents are being asked to accelerate from 0 mph with respect to the parachutist to upwards of 120+ mph with respect to the parachutist, as it enters the wind, in a matter of a very few seconds. The reserve free-bag 16 and its contents respond at their own rate to these forces. In particular, under such conditions the packed reserve parachute 39 may try to compress and move down within the reserve free-bag 16, and the suspension lines 44 may act to extract themselves from the line stows 35, 28.

A reserve parachute 39 is packed in a particular manner to ensure that as the canopy portion emerges from the reserve free-bag 16 it will catch air and inflate properly, as is known in the art. If the canopy portion of the reserve parachute 39 has shifted inside the reserve free-bag 16 due to these extreme forces, the reserve parachute 39 may not deploy properly, and this may lead to a malfunction. Likewise, the suspension lines 44 are stowed to permit controlled unstowing. The process of unstowing also slows the separation of the reserve free-bag 16 from the parachutist, which subsequently influences the rate of inflation of the reserve parachute 39. If the suspension lines 44 work free from the line stows, a deployment malfunction may occur resulting from uncontrolled line deployment (i.e., “line dump”).

A certain amount of unstowed suspension lines 44 toward the harness end is necessary for proper operation, so that the reserve free-bag 16 can begin the extraction process without the added resistance that results from unstowing lines. (The forces available to extract the reserve free-bag are relatively small at the start of the extraction process, but they gain strength as extraction proceeds. For this reason it is best not to require the extraction system to overcome the resistance offered by unstowing lines early on in the extraction process). The greater the amount of unstowed line, the higher the chances for line knotting. If all the lines unstow prematurely, the reserve free-bag 16 may reach “line stretch” (i.e., where the parachute suspension lines are fully stretched out and the parachute is stretched out) unrestrained by the slowing forces of unstowing lines. This can result in an even more rapid deployment of the reserve parachute 39 than intended, and such an opening can impart significant unwelcome forces on the parachutist.

If a parachute were to enter the wind unconstrained by a bag, which can happen if the stowed lines unstowed too soon and the bag releases the parachute, the parachute may inflate extremely fast, and this may happen while the parachute suspension lines are becoming taut (i.e., an out of sequence opening), which could result in a situation where a parachutist is falling at near terminal velocity under a nearly inflated, very slowly descending canopy. The moment the parachutist reaches the ends of the suspension lines 44, there will be a very sudden deceleration because the deceleration is not spread out over the normally slower deployment sequence, because the deployment has already occurred in this type of malfunction. For this reason it imperative that sequencing line stows 35 be chosen such that they exert enough force on the suspension lines 44 to retain them even during the most aggressive circumstances, but release them in sequence when appropriate. Likewise, line stows 28 are chosen to retain stowed lines under a range of circumstances, yet release when necessary. In an embodiment, line stows 28 may not exert as much force on stowed lines as the sequencing line stows 35 would. This would reduce the resistive force of unstowing suspension lines 44 during deployment, thereby hastening deployment of the reserve parachute 39. The benefit of a quicker deployment is thought to outweigh the heightened risk of a line dump.

In addition to enabling a stowing and sequenced release of the suspension lines 44, line stows 28 also serve to support the weight of the remainder of the suspension lines 44 not stowed in the sequencing line stows 35, thereby isolating the upper section 46 of the suspension lines 44 from any influence of the suspension lines 44 not stowed in the sequencing line stows 35. This affords greater control and predictability of the release characteristics of sequencing line stow 34, and therefore properly sequenced deployment of the reserve parachute 39.

The reserve parachute 39 is locked inside the reserve free-bag 16 by closing flap 24 as long as suspension lines 44 are stowed in sequencing line stows 35. To prevent shifting of the reserve parachute 39 within the interior 33 of the reserve free-bag 16, divider 32 is utilized. As long as suspension lines 44 are stowed in sequencing line stows 35, divider 32 keeps the upper reserve parachute portion 42 in the upper compartment 36, and the lower reserve parachute portion 40 in the lower compartment 34. Sequencing line stows 35 may exert a relatively high retention force on the stowed suspension lines 44 because it is imperative the closing flap 24 and divider 32 remain engaged until the reserve free bag 16 is outside the reserve container 14. Thus, because the sequencing line stows 35 are appropriately selected to exert sufficient force on the suspension lines 44 that they do not release them prematurely. Even in the most demanding extraction of the reserve free-bag 16 from the reserve container 14, the reserve parachute 39 will remain inside the reserve free-bag 16, and the reserve parachute 39 will remain staged within the reserve free-bag 16 as intended. Only when sequencing line stows 35 release their stowed suspension lines 44 will the closing flap 24 and divider 32 be released, thereby freeing the reserve parachute 39 to emerge from the reserve free-bag 16. This will only happen once the reserve free-bag 16 has been extracted from the reserve container 14, because it is the upper portion 46 of the suspension lines 44 that are stowed in the sequencing line stows. As a result, only when the remainder of the suspension lines 44 have been unstowed and the suspension lines 44 have started to become taut will there be sufficient force present in the upper portion 46 of the suspension lines 44 to extract the upper portion 46 of the suspension lines 44 from the sequencing line stows 35. Until that time the upper portion 46 of the suspension lines 44 remains isolated from the influence of the remainder of the suspension lines 44, and thus they remain securely in the sequencing line stows 35. Further, line stows 28 press against closing flap 24, sandwiching it between line stows 44 and the lower reserve portion 40, which helps hold closing flap 24, as well as the lower reserve portion 40, in place.

In no case can the geometry of the reserve free bag 16 be such that it inhibits extraction of the reserve free bag 16 from the reserve container 14. This means that the reserve free bag 16 and anything attached to it must be shaped such that no point is asked to pass through portion of the reserve container 14 that is narrower than that point of the reserve free bag 16 and attachments during extraction. This can be accomplished in an embodiment by ensuring that a reserve free bag assembly depth 41, i.e., an outer measurement of the depth of the reserve free bag 16 and anything attached to it, such as stowed lines 44, is approximately constant along the height 43 of the reserve free bag. In another embodiment this could be accomplished by decreasing the reserve free bag assembly depth 41 in the lower compartment 34, either gradually or in steps. In an embodiment where reserve free bag assembly depth 41 is approximately the same along the entire reserve free bag height 43, the reserve free bag assembly depth 41 in the region of the upper compartment 36 of the reserve free bag 16 is defined by an upper reserve parachute portion depth 45, (plus the thickness of the reserve free bag 16 material). In the lower compartment 34 the reserve free bag 16 must accommodate the lower reserve parachute portion 40 and the stowed lines 44 in the same reserve free bag assembly depth 41. As a result, the reserve free bag assembly depth 41 in the region of the lower reserve parachute portion 40 is defined by a lower parachute portion depth 47 and a line stow depth 49, (plus the thickness of the reserve free bag 16 material and cover 30 material) which must be approximately equal to that of the upper reserve parachute portion depth 45. In other embodiments the lower parachute portion depth 47 and a line stow depth 49 may be less than that of the upper reserve parachute portion depth 45.

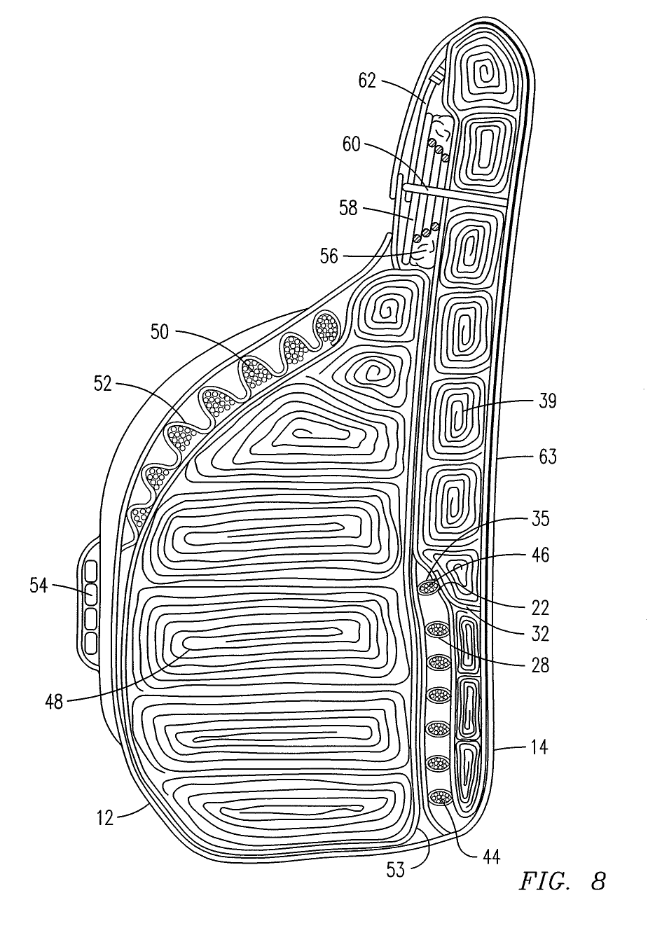

FIG. 8 shows a cross section of a packed parachute container system of FIG. 2. The reserve container 14 housing a reserve parachute 39, divider 32, sequencing line stows 35, line stows 28, reserve suspension lines 44, and a back wall 63 of the reserve compartment are visible. Also shown are a main container 12 housing a main parachute 48 retained in a main parachute deployment-bag 53, main parachute suspension lines 50, main parachute line stows 52, and static-line 54. Components of a pilot chute based reserve free-bag extraction system are visible, including a reserve pilot chute 56, a reserve pilot chute spring 58, which is compressed and held in place by reserve closing loop 60 and reserve closing pin 62. As is known in the art, when a handle (not shown) is pulled, reserve closing pin 62 pulls free from reserve closing loop 60. This frees pilot chute spring 58 to launch pilot chute 56 into the air behind the parachutist. The reserve pilot chute 56 is connected to the reserve free-bag 16 via a reserve bridle (not shown). As the pilot chute 56 catches air and inflates, it rises over the parachutist's head and pulls the reserve free-bag 16 from the reserve container 14 along a deployment line parallel to the parachutist. If the parachutist is not vertically oriented prior to extraction of the reserve free-bag 16, the resistive force of the reserve pilot chute 56 will work to orient the parachutist into an orientation parallel to the line of deployment. It can be seen in this embodiment that it is important for reserve free bag assembly depth 41 not increase toward the bottom of the reserve free bag 16, as it would increase the extraction force required.

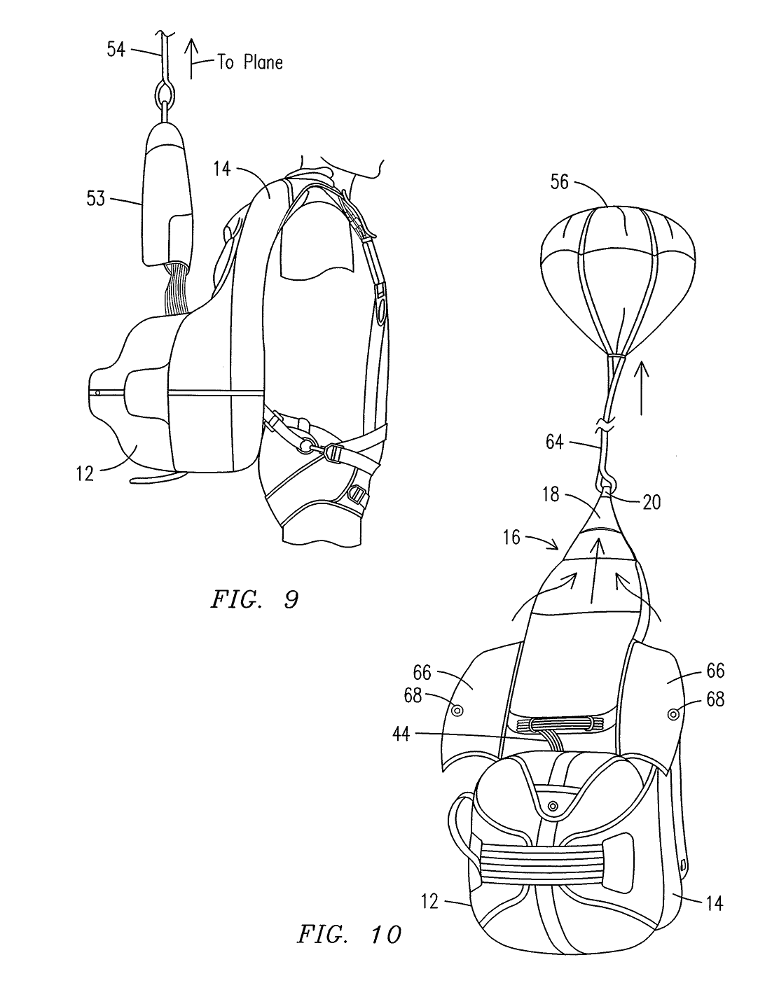

FIG. 9 depicts the parachute system 10 of the present invention in operation at the point where the static-line 54 attached to the aircraft has released the main compartment and is extracting the main parachute deployment-bag 53 inside which the main parachute 48 is retained. As can be seen, the static-line, and thus the line of deployment, and the parachutist are all oriented parallel to each other during this deployment. The parachutist continues to descend along the line of descent, and the main parachute deployment-bag 53 is free to deploy along the line of deployment unobstructed by the reserve container 14. The deployment process of the main parachute is known to those in the art and has been discussed above.

FIG. 10 depicts an extraction of the reserve parachute of the parachute system 10 of the present invention. In FIG. 10 the main canopy is shown still in the main container 12. This could happen if, for example, the static-line breaks, or if the static-line is not properly attached to the aircraft. In such a scenario the parachutist simply activates the reserve parachute extraction system by pulling on the release handle as discussed above. Reserve parachute extractions are not limited to this scenario, however. Other scenarios are discussed later.

Reserve parachute extraction systems are known in the art. Similar to the deployment of the main parachute, reserve container 14 contains four reserve compartment flaps 66, each with a reserve flap grommet hole 68. When closed, the reserve flap grommet holes 68 line up. A closing loop connected at one end to a spring loaded pilot chute is fed through the grommets holes 68, and reserve closing pin 62 is placed in the reserve closing loop 60. This locks the compressed reserve pilot chute in place, as well as locks the reserve compartment flaps 66 in place around the reserve free-bag 16. Once the parachutist activates the reserve parachute extraction system by pulling the closing pin 62 from the reserve closing loop 60, the reserve pilot chute 56 is released, springs out, catches air, and distances itself from the parachutist. The reserve pilot chute 56 continues to pull away from the parachutist along the deployment line, and when the reserve pilot chute bridle 64 becomes taut, it begins to extract the reserve free-bag 16. The reserve free-bag 16 holds the reserve parachute 39, and the reserve parachute 39 is attached to the harness 15 at the parachutist's shoulders via the suspension lines 44. The suspension lines 44 are routed to the harness connection point between the reserve free-bag 16 and the back wall 63 of the reserve compartment. This slack in the parachute suspension lines (i.e., unstowed portion of the parachute suspension lines) allows the pilot chute 56 to begin to extract the reserve free-bag 16 from the reserve container 14 because resistance to extraction is lower.

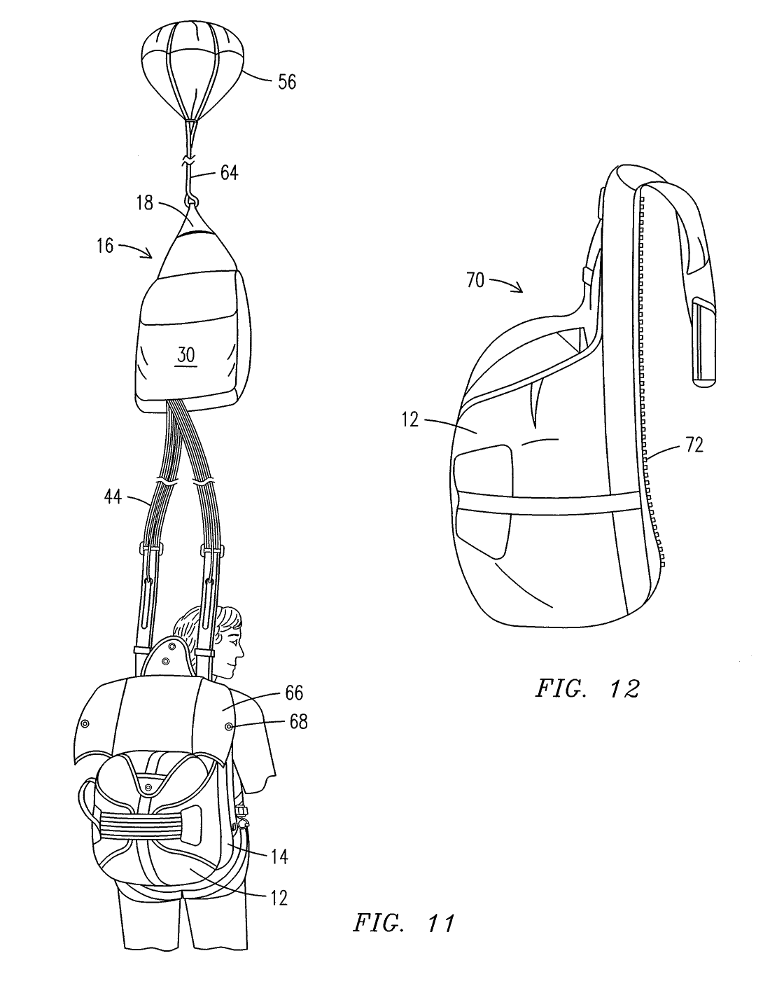

FIG. 11 is the deploying reserve parachute of FIG. 10 at the point where the reserve pilot chute 56 has completely extracted the reserve free-bag 16 and has pulled it to the point where the lower, unstowed portions of the parachute suspension lines have become essentially taut, which in turn begins to unstow the stowed suspension lines. The stowed parachute suspension lines are stowed under cover 30. As the reserve pilot chute 56 continues to distance itself from the parachutist, the suspension lines 44 begin to unstow from the line stows 28 (under cover 30). Upon the unstowing of the parachute suspension lines 44 from the sequencing line stows, the closing flap 24 and divider 32 disengage, thereby freeing the reserve parachute 39 to emerge from the reserve free-bag, catch air, inflate, and safely assist the parachutist to the ground. The reserve free-bag remains attached to the reserve pilot chute and they descend independently.

A further advantage of this configuration is that it can employ reserve parachute extractions systems used in sport parachute systems. Such systems may incorporate a reserve static line between a main parachute riser and the reserve closing pin. In the event a main parachute it cut away, the reserve static line extracts the reserve closing pin from the reserve closing loop as the parachutist separates from the jettisoned main canopy. Once the reserve closing pin is extracted the reserve pilot chute is free to enter the airstream and deploy the reserve parachute in the typical manner. Another system employs an automatic activation device (AAD). The AAD has sensors that gauge the altitude and fall rate of a parachutist. If certain conditions are met, the AAD cuts the reserve closing loop. At this point the reserve pilot chute is free to enter the airstream and deploy the reserve parachute in the typical manner.

A recent innovation goes one step beyond and uses the force generated by a jettisoned main canopy to pull the reserve closing pin from the reserve closing loop; the force generated by the jettisoned main canopy is utilized to extract the reserve parachute. Such a system is described in provisional patent application Ser. No. 60/881,186 titled “Tandem Parachute System” filed Jan. 19, 2007, by David St. Clair et al. This system is also described in non provisional application Ser. No. 12/009,534 titled “Parachute Systems” filed Jan. 18, 2008, by David St. Clair and Edward Strong. Both references are incorporated by reference in their entirety. In such a system, both the jettisoned main parachute and the reserve pilot chute are part of the reserve parachute extraction system. In an embodiment, the reserve static line connecting one of the main parachute risers to the reserve closing pin is also releasably connected to the reserve pilot chute bridle. If the force on the reserve pilot chute bridle generated by the jettisoned main parachute is greater than the force on the reserve pilot chute bridle generated by the activated reserve pilot chute, then the jettisoned main parachute remains connected to the reserve pilot chute bridle and extracts the reserve parachute. In such a scenario the jettisoned main canopy is described to be working as an “air anchor.” In addition, in this scenario the reserve pilot chute may be contributing to the extraction of the reserve parachute. If the force generated by the reserve pilot chute is greater than the force generated by the jettisoned main parachute, the mechanism releases the jettisoned main canopy and the reserve pilot chute extracts the reserve parachute. (The mechanism that releases a main canopy also serves to release the bridle from main parachute that has never been deployed.) In the rare event that the jettisoned main and the reserve pilot chute exert comparable forces, both would contribute to the extraction of the reserve parachute. In the majority of instances, the force generated by the main parachute is going to be much greater than the force generated by the reserve pilot chute. As a result, parachute systems that employ a system such as this will likely deploy the reserve parachute much quicker. Consequently, parachute operations such as static-line jumping may be conducted using these more effective reserve parachute extraction systems that were unavailable until this invention, and this may result in fewer incidents.

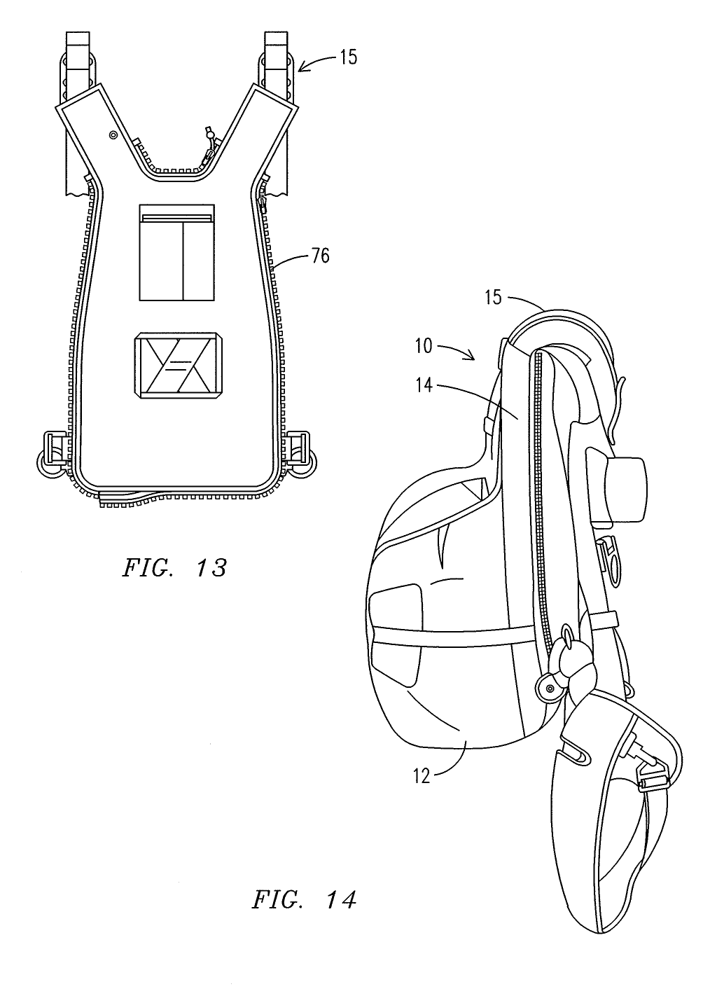

In an embodiment the container system and the harness may be detachably connected to each other, however they may also be permanently connected to each other. An embodiment with a detachable connection may be accomplished by a set of zippers. Typically a container is designed to house a parachute of a certain size, and perhaps one size larger or smaller. There are, however, a wide range of parachute sizes available for a wide range of purposes. If a parachutist were to need a different size parachute, a whole new parachute system would be required. However, with this innovative system, multiple different containers with multiple different parachute sizes could be attached to the same harness. FIG. 12 shows a container system 70 with container zippers 72. FIG. 13 shows the harness 15 with harness zippers 76. FIG. 14 shows a parachute system 10 using a container system 70 zippered to a harness 15.

It has been shown that the present invention is an improvement over the parachute systems used in this type of parachute operation. By moving the reserve parachute to the parachutist's back, between the main container and the parachutist, the innovative system retains the time tested main parachute deployment system, and incorporates advantages that come with having a reserve on the parachutist's back. With the new configuration the parachutist has better forward visibility, greater cargo carrying capacity, a safer configuration for a parachutist under a deployed reserve parachute, a safer configuration (i.e., a backpad) for a parachutist with an undeployed reserve rolling backwards during a landing, and the ability to incorporate faster and more efficient reserve parachute extraction systems that, until this invention, were only available in sport parachuting operations.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

What is claimed is:

1. A parachute container system comprising:
a reserve compartment;
a main compartment;
a reserve parachute pathway configured to enable a connection between a reserve parachute canopy and a reserve parachute connection point external to the parachute container system when a reserve parachute canopy is positioned in the reserve compartment; and
a main parachute pathway configured to enable a connection between a main parachute canopy and a main parachute connection point external to the parachute container system when a main parachute canopy is positioned in the main compartment;
wherein when the parachute container system is positioned on a parachutist at least a portion of the reserve compartment is disposed between the main compartment and the parachutist.

2. The parachute container system of claim 1, comprising a reserve parachute extraction system comprising a reserve pilot chute connected to a reserve pilot chute bridle, and a reserve pilot chute activation system.

3. The parachute container system of claim 2, wherein the reserve parachute extraction system further comprises a reserve free-bag.

4. The parachute container system of claim 3, wherein the reserve free-bag further comprises an extraction assist pocket configured to catch air to aid in the extraction of the reserve free-bag.

5. The parachute container system of claim 4, wherein the extraction assist pocket is disposed at a top of the reserve free-bag.

6. The parachute container system of claim 3, wherein the reserve free-bag further comprises an internal structural member configured to help the free-bag retain a flat configuration when containing a packed reserve parachute.

7. The parachute container system of claim 3, wherein the reserve free-bag further comprises a divider that:
divides the free-bag into an earlier-to-release compartment and a later-to-release compartment;
divides a packed reserve parachute into an earlier-to-be-released portion and a later-to-be-released portion; and
retains the later-to-be released portion in the later-to-release compartment until disengaged.

8. The parachute container system of claim 7, wherein the divider further aids in maintaining a flat free-bag shape.

9. The parachute container system of claim 7, wherein the divider of claim 7 further aids in maintaining a flat free-bag shape, and wherein the reserve parachute extraction system further comprises a reserve parachute deployment sequencing system comprising:
a free-bag closing flap that retains the reserve parachute in the reserve free-bag until disengaged; and
a sequencing line stow connected to the divider,
wherein the divider and the free-bag closing flap are engaged by the sequencing line stow when the sequencing line stow is routed through a free-bag sequencing line stow opening, through a free-bag closing flap sequencing stow opening, and engaged by a stowed reserve parachute suspension line, and
wherein the sequencing line stow releases the reserve parachute suspension line as the reserve free-bag increases distance from the parachutist during deployment, which disengages the free-bag closing flap and the divider.

10. The parachute container system of claim 9, wherein an upper region of the reserve parachute suspension line is stowed in the sequencing line stow.

11. The parachute container system of claim 2, wherein the reserve parachute exits the reserve compartment through an upper portion of the reserve compartment.

12. The parachute container system of claim 2, wherein when the parachute container system is vertically oriented an area above the main container is unobstructed, thereby allowing a main parachute to deploy unobstructed.

13. The parachute container system of claim 2, wherein the reserve compartment is substantially flat and when worn by a parachutist, substantially parallel to the parachutist's back.

14. The parachute container system of claim 2, wherein the main compartment is disposed lower than the reserve pilot chute when the parachute container system is vertically oriented, thereby not interfering with operation of the reserve parachute extraction system.

15. The parachute container system of claim 2, wherein the reserve parachute extraction system comprises an extraction force selector that releasably couples a main parachute to the reserve pilot chute bridle and ensures an extraction force delivered to the reserve parachute is at least the dominant of force originating from the reserve pilot chute, and force originating from a jettisoned main parachute.

16. The parachute container system of claim 15, wherein the extraction force selector releases the jettisoned main parachute if the dominant force originates from the reserve pilot chute.

17. A parachute system comprising the parachute container system of claim 2, and a harness.

18. The parachute system of claim 17, wherein the parachute container system is removably attached to the harness.

19. The parachute system of claim 17, wherein the parachute container system is permanently attached to the harness.

20. A parachute system comprising:
a harness;
a container system comprising a reserve compartment and a main compartment; and
a reserve parachute extraction system comprising a reserve pilot chute, a reserve free-bag, and a reserve pilot chute activation system;
wherein at least a portion of the reserve compartment is disposed between the main compartment and the harness.

21. The parachute system of claim 20, wherein the container system is removably secured to the harness.

22. The parachute system of claim 20, comprising a sequencing system comprising:
a divider configured to divide an interior of the reserve free-bag into a first compartment and a second compartment, and configured to divide a reserve parachute packed in the free-bag into a lower portion and an upper portion when the divider is engaged, wherein the divider keeps the upper portion of the reserve parachute in the second compartment until disengaged,
a free-bag closing flap configured to retain the reserve parachute in the reserve free-bag when engaged; and
a sequencing line stow connected to the divider, that engages the divider and the free-bag closing flap when routed through a free-bag sequencing line stow opening, through a free-bag closing flap sequencing stow opening, and engaged by a stowed reserve parachute suspension line;
wherein the reserve parachute suspension line disengages from the sequencing line stow during deployment of the reserve parachute, thereby disengaging the free-bag closing flap and the divider, freeing the reserve parachute to emerge from the reserve free-bag.

23. The parachute system of claim 20, wherein when the parachute system is vertically oriented and an area above the main container is unobstructed, thereby allowing a main parachute to deploy unobstructed.

24. The parachute system of claim 20, wherein the reserve compartment is substantially flat and parallel to a parachutist's back.

25. The parachute system of claim 20, wherein the main compartment is disposed lower than the reserve pilot chute when the parachute system is vertically oriented, thereby not interfering with operation of the reserve parachute extraction system.

26. A parachute container system comprising:
a reserve compartment configured to contain a reserve parachute during a parachute jump, wherein the reserve compartment is configured to enable deployment of the reserve parachute during the parachute jump; and
a main compartment configured to contain a main parachute during a parachute jump wherein the main compartment is configured to enable deployment of the main parachute during the parachute jump,
wherein when the parachute container system is positioned on a harness, a container main wall spans from a shoulder area of the harness to a lower back area of the harness, and at least a portion of the reserve compartment is disposed between the main compartment and the container main wall.
